(19) United States
(12) Patent Application Publication
(10) Pub. No.: US 2019/0142239 A1
(43) Pub. Date: May 16, 2019

(54) TOWEL WITH INTERGRATED CLEANING AGENT

(71) Applicant: Robert M Quigley, Orlando, FL (US)

(72) Inventor: Robert M Quigley, Orlando, FL (US)

(21) Appl. No.: 15/809,610

(22) Filed: Nov. 10, 2017

(51) Int. Cl. A47L 13/17; D03D 27/08

(52) U.S. Cl. CPC A47L 13/17; B60S 3/045; D03D 27/08

(57) ABSTRACT

A towel with an integrated cleaning agent includes a towel body having a pocket that is interposed between a front surface, a rear surface, a pair of opposing side edges, a bottom edge and a top edge. A cleaning agent having a porous fabric body is positioned within the pocket of the towel body. The cleaning agent includes a cleaning solution that is incrementally released through the porous body and the towel body when activated by water. The towel body is constructed from any combination of smooth and textured materials, and includes an opening that is in communication with the pocket for receiving and positioning the cleaning agent therein.

### TECHNICAL FIELD

The present invention relates generally to cleaning products, and more particularly to towel with an integrated cleaning agent.

### BACKGROUND

The statements in this section merely provide background information related to the present disclosure and may not constitute prior art.

There are no shortage of commercially available cleaning products such as various soaps, buckets, towels, sponges and brushes, for example, that are used every day to wash and clean items such as boats, motorcycles and automobiles, for example. Indeed, one of the largest users of cleaning products are automobile dealerships who must frequently clean vehicles on their lots to make them more attractive to potential buyers.

In either instance, washing a vehicle typically requires the use of a bucket that is filled with a combination of water and detergent, into which a towel or other cleaning items must be repeatedly dunked and rinsed. In this regard, it is not uncommon for users to pour a random amount of detergent into the bucket, as opposed to accurately measuring the same. As such, when too much soap is used the surface of the vehicle will be prone to excessive spotting. Conversely, when too little soap is used the dirt may not be adequately removed.

Moreover, even when the proper amount of soap is used, the water in the bucket becomes increasingly soiled as the washing procedure continues. As such, the user must continually dump the entire mixture and begin again. Such a situation results in additional work for the user and leads to excessive chemicals in the form of the soapy water that ultimately enters the ground or sewage systems.

Accordingly, it would be beneficial to provide a towel with an integrated cleaning agent that can reduce the time and effort required to wash a vehicle or other such item, and that can eliminate the drawbacks described above.

### SUMMARY OF THE INVENTION

The present invention is directed to a towel with an integrated cleaning agent. One embodiment of the present invention can include a towel body having a pocket that is interposed between a front surface, a rear surface, a pair of opposing side edges, a bottom edge and a top edge. A cleaning agent having a porous fabric body can be positioned within the pocket of the towel body. The cleaning agent can include a cleaning solution located within the porous fabric body that is incrementally released through the porous body and the towel body when activated by water.

The towel body can be constructed from any combination of smooth and textured materials, and can also include an opening that is in communication with the pocket for receiving and positioning the cleaning agent therein. One or more connectors can be positioned along the towel body to secure the opening into an open or a closed position.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of a towel with integrated cleaning agent that is useful for understanding the inventive concepts disclosed herein.

FIG. 2 is a top view of the cleaning agent of the towel, in accordance with one embodiment of the invention.

FIG. 3 is a top view of the towel with integrated cleaning agent, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described throughout this document for use in washing various types of vehicles, this is for illustrative purposes only. As such, the inventive concepts disclosed herein can be utilized in any industry to wash and/or wipe any type of surface.

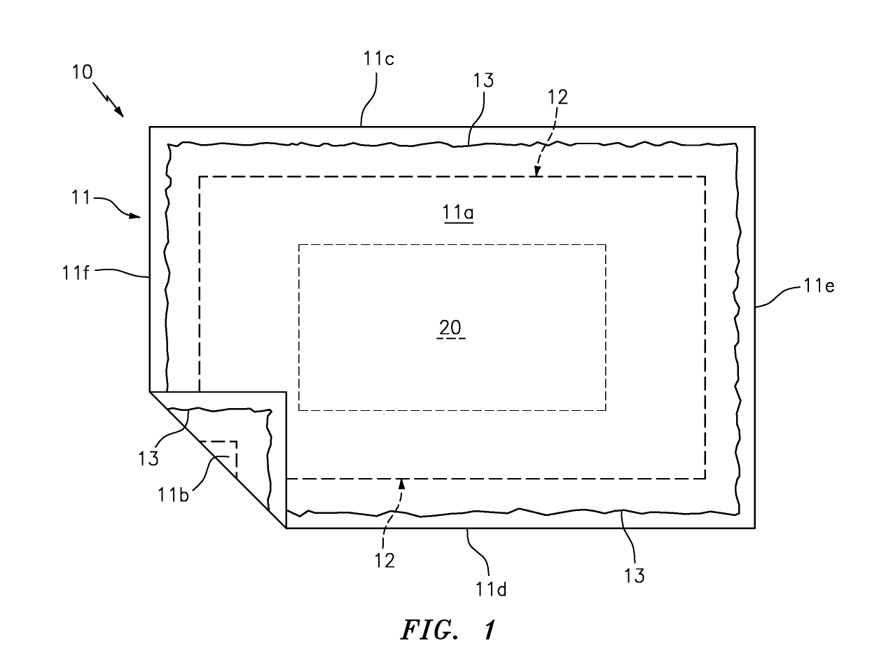

Various embodiments of a towel with an integrated cleaning agent 10 are provided throughout the drawings to aid in understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of a towel with an integrated cleaning agent 10, that includes a towel body 11 and a cleaning agent 20 positioned therein.

As shown, the towel body 11 can include a front surface 11a, a rear surface 11b, a top end 11c, a bottom end 11d, and a pair of opposing sides 11e-11f that define a hollow interior pocket 12 for receiving and storing the cleaning agent 20. Depending on the intended use/industry for which each towel is to be manufactured, the front surface 11a and the rear surface 11b may be identical, or may be different, in terms of construction material, and/or texturing, for example.

As such, the front and/or rear surface may be constructed from a soft cloth material such as terrycloth cotton, for example. Cotton is a common and widely accepted material for towels as it is soft, absorbent, and has a smooth texture that is ideal for gently washing and wiping fine smooth surfaces such as automotive paint. Likewise, the front and/or rear surface may be constructed from an abrasive (e.g., rough textured) material such as wool, polyester or rayon, for example. Such materials having a rough textured surface that is ideal for thoroughly scrubbing accessories such as tires and rims, for example.

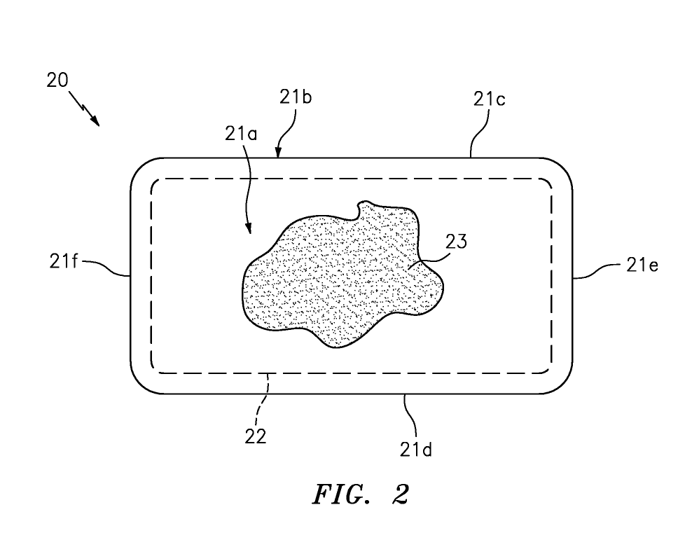

FIG. 2, illustrates one embodiment of the cleaning agent 20. As shown, the agent can also include a porous body having a front surface 21a, a rear surface 21b, a top end 21c, a bottom end 21d, and a pair of opposing sides 21e-21f that define a hollow interior space 22 containing a cleaning solution 23.

As described herein, the cleaning solution can include, comprise or consist of any combination of solid, powdered and/or granular substances that can, essentially, attach to the molecules of grease, dirt and other impurities to aid in the removal of such elements when activated by water. Several nonlimiting examples of suitable cleaning solution substances include, but are not limited to, various surfactants (e.g., surface active agents), water-soluble sodium or potassium salts of fatty acids, alkaline shampoo, and/or alkylbenzenesulfonates, for example.

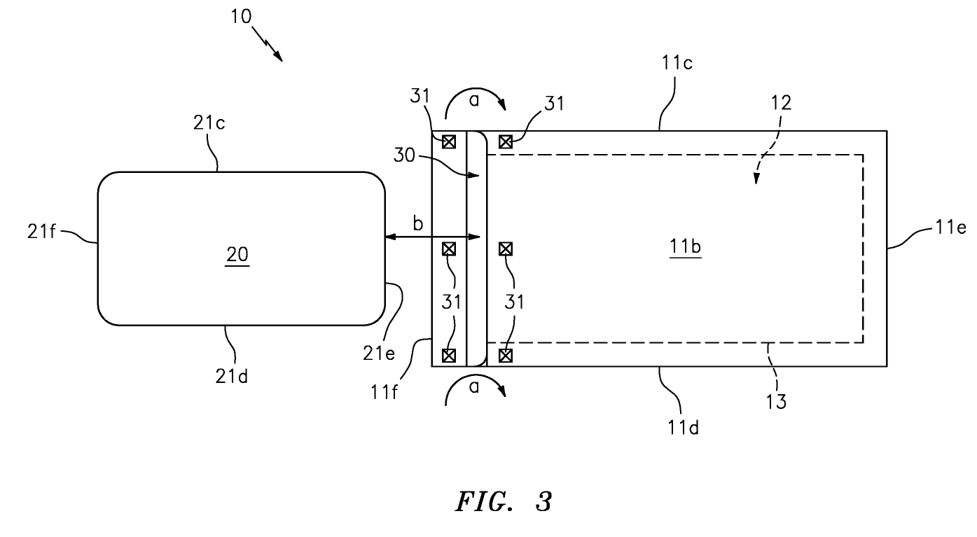

In the preferred embodiment, the towel body and the agent body can each include the illustrated rectangular shape, and the front and rear surfaces of each can comprise substantially rectangular pieces of cloth or other such material that are joined together via one or more seam connectors 13, such as silicone gel, fabric glue or stitches, for example. Of course, any number of other shapes, sizes, materials and/or seam connectors are also contemplated. To this end, other embodiments are contemplated wherein the towel body includes a different shape than the agent body (see FIG. 3) and/or multiple different cleaning agents 20 are disposed within a single towel body.

As shown in FIG. 3, one embodiment of the towel with integrated cleaning agent 10 can also include functionality for allowing the cleaning agent 20 to be removably secured within the towel body 11. As shown, one side of the towel body can include a sleeve/opening 30 for accessing the pocket 12 defined by the body segments 11a-11f. To this end, a plurality of connectors 31, such as hook and loop elements, for example, can be secured onto the towel body in order to allow a user to selectively position the sleeve 30 between an open or closed position as shown by arrow a.

As shown by arrow b, one or more cleaning agents 20 can be inserted and removed through the sleeve 13 of the towel main body, in order to allow the towel body to be reusable via replacement cleaning agents 20. Such a feature aims to prevent waste associated with discarding the entire towel device 10 after a single use.

Although dimensions are not critical, in one preferred embodiment, the towel 10 can include a rectangular shape having a length (e.g., distance between sides 11e-11f) of approximately 12 inches; and a width (e.g., distance between sides 11c-11d) of approximately 8 inches. Likewise, the cleaning agent 20 can preferably include a generally oval shape having a length (e.g., distance between sides 21e-21f) of approximately 6 inches; and a maximum width (e.g., distance between sides 21c-21d) of approximately 4 inches.

Such dimensions are particularly useful to achieve a 50% ratio of cleaning agent to towel body, so as to prevent too much or too little cleaning agent from being released during use. Moreover, the oval shape and above described dimensions of the cleaning agent are specifically sized to fit and conform to the shape of an adult hand, so as to provide the user with an ergonomic handhold during use, thereby eliminating hand cramping and other issues typically encountered when cleaning with a regular towel or rag. Of course, any number of other dimensions are also contemplated.

In operation, the device 10 can be utilized to wash and clean any number of different objects such as cars, boats and/or motorcycles, for example, without the need for a water bucket and/or separate cleaning detergent. In this regard, a user can simply apply water from a hose onto the towel and/or object itself, so as to allow the water to penetrate the towel body. Once the cleaning agent is wet, the cleaning solution within the agent will activate and begin to flow through the towel body onto the surface of the vehicle.

As the user continues to apply fresh water, the dirt and grease will be removed from both the vehicle and the towel 10, thereby ensuring the towel body is clean whenever it is in contact with the vehicle. Moreover, as the cleaning solution is incrementally released from the cleaning agent, the device advantageously releases the appropriate ratio of soap to water, thereby eliminating issues associated with too much or too little soap. Finally, as the detergent remains in a solid form until it is used, any remaining cleaning solution material remains contained within the cleaning agent body for proper disposal.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A towel device, comprising:
a towel body having a front surface, a rear surface, a plurality of edges, and a first shape;
a pocket that is located between the front and rear surfaces of the towel body; and
a cleaning agent having a second shape that is positioned within the pocket of the towel body.

2. The device of claim 1, wherein the cleaning agent includes a porous body that is embedded with a cleaning solution.

3. The device of claim 2, wherein the towel body is constructed from a material that absorbs water, and the cleaning solution is activated by water.

4. The towel device of claim 1, wherein the towel body is constructed from two separate sheets of material that are joined together by a plurality of seam connectors to form the pocket.

5. The device of 4, wherein the two sheets are constructed from soft absorbent fabrics.

6. The device of 5, wherein the two sheets of fabric consist of terrycloth cotton.

7. The device of 4, wherein the two sheets are constructed from an abrasive fabric.

8. The device of 7, wherein the two sheets of fabric include, at least one of a wool, polyester and rayon material.

9. The device of 4, wherein one of the two sheets is constructed from a soft absorbent fabric, and the other of the two sheets is constructed from an abrasive fabric.

10. The device of 9, wherein the seam connectors include, at least one of, a silicone gel, a fabric glue and stitches.

11. The device of claim 1, wherein the cleaning agent is removably secured within the pocket of the towel body via a sleeve positioned along the towel body.

12. The device of claim 1, wherein the first shape and the second shape are identical.

13. The device of claim 1, wherein the first shape and the second shape are different.

14. The device of claim 1, wherein the first shape is rectangular, and the second shape is oval.
